(19) United States
(12) Patent Application Publication
(10) Pub. No.: US 2019/0331047 A1
(43) Pub. Date: Oct. 31, 2019

(54) Vehicle Throttle Locking Circuit and Method Thereof

(71) Applicants: William Wei-Lun Tsai, (US); Top 1 Green Development Co. LTD., Taipei City (TW)

(72) Inventor: William Wei-Lun Tsai, Irvine, CA (US)

(21) Appl. No.: 16/507,448

(22) Filed: Jul. 10, 2019

Related U.S. Application Data
(63) Continuation-in-part of application No. 15/297,138, filed on Oct. 19, 2016.

(30) Foreign Application Priority Data
Oct. 23, 2015 (TW) 104134768

(51) Int. Cl. F02D 41/22; B60R 25/04; B60R 25/34; F02D 41/12

(52) U.S. Cl. CPC F02D 41/22; B60R 25/04; B60R 2025/0415; F02D 41/123; B60R 25/34

(57) ABSTRACT

A vehicle throttle locking circuit and method are provided. A control unit receives detection voltages from a pedal sensor and, when a clamping actuation signal is ON, digital clamping voltages are gradually reduced according to the detection voltages. A D/A conversion unit converts the digital clamping voltages to analog clamping voltages. A variable voltage clamping unit clamps the detection voltages according to the analog clamping voltages. The gradual reduction of the digital clamping voltages are stopped when the detection voltages are already clamped at an idle condition so that the pedal is effectively locked at the idle condition. As such, the present invention not only provides anti-theft function, but also avoids traffic accident and hazard to the safety of the driver or passers due to the vehicle's sudden loss of power.

### CLAIM OF PRIORITY

This application is a Continuation-In-Part of U.S. application Ser. No. 15/297,138 entitled to inventors William Wei-Lun Tsai, filed on Oct. 19, 2016 and entitled “Vehicle Throttle Locking Circuit and Method”, the entire disclosures of which are incorporated herein by reference.

### FIELD OF THE INVENTION

The present invention is generally related to anti-theft devices for vehicles, and more particular to a throttle locking circuit and a related method providing both anti-theft and road safety functions.

### BACKGROUND OF THE INVENTION

The following description and examples are not admitted to be prior art by virtue of their inclusion in this section.

Motor vehicles satisfy people's traveling requirement and provide people great convenience. However, vehicle theft is always a concern to vehicle owners.

To address this concern, vehicle anti-theft devices equipped on the vehicles are widely popular. In early days, these devices aim at providing alarms to alert vehicle owners so as to deter the burglars. However the effectiveness of these devices is only limited.

Therefore, there are teachings that cut off a stolen vehicle's power to prevent the stolen vehicle from getting away. These are effective means. However, there are safety concerns as a vehicle suddenly losing its power may cause harm to people around.

To overcome this issue, R.O.C. Taiwan Patent No. M466837 teaches an anti-theft device that disables a vehicle's throttle. But the control unit of the teaching encounters difficulty in implementation and further improvement is required.

Accordingly, it is necessary to build a new device for , such that it will be more advantageous to improve the interferometer than the prior art.

### BRIEF SUMMARY OF THE INVENTION

Therefore, an objective of the present invention is to provide a vehicle throttle locking circuit and method so that both anti-theft and driving safety are effectively achieved.

To achieve this and other objectives, the throttle locking circuit is applied to a vehicle equipped with an accelerator pedal sensor and an Electronic Control Unit (ECU). The pedal sensor outputs detection voltages corresponding to a depth of the pedal being stepped on to the ECU.

The throttle locking circuit includes a control unit, a digital-analog (D/A) conversion unit, and a variable voltage clamping unit. The control unit is coupled to the pedal sensor for receiving a clamping actuation signal and, when the clamping actuation signal is ON, outputting digital clamping voltages according to the detection voltages. The D/A conversion unit is coupled to the control unit for converting the digital clamping voltages into analog clamping voltages. The variable voltage clamping unit is coupled to the D/A conversion unit for clamping the detection voltages according to the analog clamping voltages.

In one embodiment, the detection voltages include a high voltage and a low voltage. The digital clamping voltages include a high digital value and a low digital value. The control unit outputs the digital clamping voltages of the high digital value and the low digital value in accordance with the high and low voltages of the detection voltages.

In one embodiment, the D/A conversion unit includes two D/A converters converting the digital clamping voltages of the high digital value and the low digital value into analog clamping voltages including a high analog clamping voltage and a low analog clamping voltage, respectively.

In one embodiment, the variable voltage clamping unit includes two variable voltage clamping circuits clamping the high and low voltages of the detection voltages according to the high and low analog clamping voltages, respectively.

In one embodiment, each variable voltage clamping circuit includes an operational amplifier, a first resistor, a transistor, and a second resistor. The operational amplifier has a positive input terminal, a negative input terminal, and an output terminal. The negative input terminal directly or indirectly receives the high or low analog clamping voltage. The first resistor has an end coupled to the output terminal. The transistor has its base coupled to another end of the first resistor and its emitter connected to ground. The second resistor has its two ends coupled to the collector of the transistor and the positive input terminal, respectively.

In one embodiment, the high and low analog clamping voltages are differential voltages, respectively. Each variable voltage clamping circuit further includes a differential amplifier between one of the D/A converter and the negative input terminal of the operational amplifier for amplifying one of the differential voltages.

In one embodiment, each differential amplifier includes a second operational amplifier, a third resistor, a second transistor, a fourth resistor, and a fifth resistor. The second operational amplifier has a positive input terminal, a negative input terminal, and an output terminal where the positive and negative input terminals receive the differential voltages, respectively. The third resistor has an end coupled to the output terminal of the second operational amplifier. The second transistor has its base coupled to another end of the third resistor and its emitter connected to ground. The fourth resistor has its two ends coupled to the collector of the second transistor and the positive input terminal of the second operational amplifier, respectively. The fifth resistor has its two ends coupled to the collector of the second transistor and a power source, respectively.

The throttle locking method is for a vehicle equipped with an accelerator pedal sensor and a ECU where the pedal sensor outputs detection voltages corresponding to a depth of the pedal being stepped on to the ECU. The method includes the following steps.

Firstly, digital clamping voltages are provided according to the detection voltages when a clamping actuation signal is ON. Secondly, the digital clamping voltages are converted to analog clamping voltages. And the detection voltages are clamped according to the analog clamping voltages.

The detection voltages include a high voltage and a low voltage. The method further includes the step of determining and recording a type of the pedal sensor according to the high and low voltages of the detection voltages.

The method further includes the step of adjusting and providing the digital clamping voltages according to relatively low values of the high and low voltages of the detection voltages and the type of the pedal sensor when the detection voltages suggest that the pedal is released to reduce speed so as to effectively lock the acceleration function of the pedal.

Reducing to the digital clamping voltage is stopped when the detection voltages are already clamped at an idle condition so as to effectively lock the pedal at the idle condition.

As described, the throttle locking circuit and method, when the clamping actuation signal is ON, gradually reduce the clamping voltages until the detection voltages are at an idle voltage. Therefore traffic accident and hazard to the safety of the driver or passers due to the vehicle's sudden loss of power are avoided. The present invention therefore not only provides anti-theft function, but also ensures driving safety.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Accordingly, the invention provides a system for limiting speed of a vehicle, which comprises a controller, coupled to a pedal sensor and a control unit of the vehicle, for receiving a clamping actuation signal, and a variable voltage clamping device, coupling to the pedal sensor, the control unit, and said controller, for clamping the detection voltages from the pedal sensor to the control unit. The pedal sensor outputs detection voltages and the control unit determines status of the vehicle. The controller, according to the detection voltages, outputs clamping voltage signals to the variable voltage clamping device to gradually lower the detection voltages to clamping voltages, when said controller receives the clamping actuation signal, if the vehicle is moving initially.

In one embodiment of the system of the present invention, the detection voltages comprise a first detection voltage and a second detection voltage lower than the first detection voltage.

In one embodiment of the system of the present invention, the variable voltage clamping device comprises a first variable voltage clamping unit for clamping the first detection voltage and a second variable voltage clamping unit for clamping the second detection voltage.

In one embodiment of the system of the present invention, the first variable voltage clamping unit comprises a first digital-analog converter and a first variable voltage clamping circuit, and said second variable voltage clamping unit comprises a second digital-analog converter and a second variable voltage clamping circuit.

In one embodiment of the system of the present invention, the first variable voltage clamping circuit comprises a first operational amplifier and said second variable voltage clamping circuit comprises a second operational amplifier.

In one embodiment of the system of the present invention, the clamping voltages comprises a first clamping voltage and a second clamping voltage.

In one embodiment of the system of the present invention, the clamping voltage signals comprise a first clamping voltage signal being transferred to the first clamping voltage by said first variable voltage clamping unit and a second voltage signal being transferred to the second clamping voltage by said second variable voltage clamping unit.

In one embodiment of the system of the present invention, an operating loop is formed among the pedal sensor, the control unit, said controller, and said variable voltage clamping device.

In one embodiment of the system of the present invention, the control unit comprises an electronic control unit for controlling an engine of the vehicle.

In one embodiment of the system of the present invention, the control unit comprises an electric motor control unit for controlling a motor of the vehicle.

In one embodiment of the system of the present invention, the clamping actuation signal is provided from a wireless communication module, such that an instruction for limiting speed of the vehicle can be sent from a mobile device.

The present invention also provides a system for limiting speed of a vehicle, which comprises a controller and means for clamping the detection voltage. The controller, coupled to a pedal sensor and a control unit of the vehicle, for receiving a clamping actuation signal, wherein the pedal sensor outputs a first detection voltage and a second detection voltage, and the control unit determines status of the vehicle.

The means for clamping the detection voltage, coupling to the pedal sensor, the control unit, and said controller, includes a first variable voltage clamping unit for clamping the first detection voltage from the pedal sensor to the control unit and a second variable voltage clamping unit for clamping the second detection voltage from the pedal sensor to the control unit respectively. The controller, according to the first detection voltage and the second detection voltage, outputs a first clamping voltage signal and a second clamping voltage signal to said clamping means to gradually lower the first detection voltage and the second detection voltage to the first clamping voltage and the second clamping voltage respectively.

In one embodiment of the optical system of the present invention, an operating loop is formed among the pedal sensor, the control unit, said controller, and said variable voltage clamping device.

In one embodiment of the optical system of the present invention, the control unit comprises an electronic control unit for controlling an engine of the vehicle.

In one embodiment of the optical system of the present invention, the control unit comprises an electric motor control unit for controlling a motor of the vehicle.

In one embodiment of the optical system of the present invention, the clamping actuation signal is provided from a wireless communication module, such that an instruction for limiting speed of the vehicle can be sent from a mobile device.

In one embodiment of the optical system of the present invention, the control unit comprises an electric motor control unit for controlling a motor of the vehicle.

Other advantages of the present invention will become apparent from the following description taken in conjunction with the accompanying drawings wherein are set forth, by way of illustration and example, certain embodiments of the present invention.

### BRIEF DESCRIPTION OF THE DRAWINGS

Further advantages of the present invention may become apparent to those skilled in the art with the benefit of the following detailed description of the preferred embodiments and upon reference to the accompanying drawings in which:

FIG. 1 is a functional block diagram showing a vehicle throttle locking circuit according to an embodiment of the present invention.

FIG. 2 is a schematic diagram showing a variable voltage clamping circuit of FIG. 1.

FIG. 3 is a flow diagram showing a vehicle throttle locking method according to an embodiment of the present invention.

FIG. 4 is a schematic illustration of a system for limiting speed of a vehicle in accordance with one embodiment of the present invention.

FIG. 5 is a schematic illustration of a conventional system for limiting speed of a vehicle.

While the invention is susceptible to various modifications and alternative forms, specific embodiments thereof are shown by way of example in the drawings and may herein be described in detail. The drawings may not be to scale. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE INVENTION

Accordingly, while example embodiments of the invention are capable of various modifications and alternative forms, embodiments thereof are shown by way of example in the drawings and will herein be described in detail. It should be understood, however, that there is no intent to limit example embodiments of the invention to the particular forms disclosed, but on the contrary, example embodiments of the invention are to cover all modifications, equivalents, and alternatives falling within the scope of the invention.

Turning now to the drawings, it is noted that the figures are not drawn to scale. In particular, the scale of some of the elements of the figures is greatly exaggerated to emphasize characteristics of the elements. It is also noted that the figures are not drawn to tie same scale. Elements shown in more than one figure that may be similarly configured have been indicated using the same reference numerals.

In the drawings, relative dimensions of each component and among every component may be exaggerated for clarity. Within the following description of the drawings the same or like reference numbers refer to the same or like components or entities, and only the differences with respect to the individual embodiments are described.

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

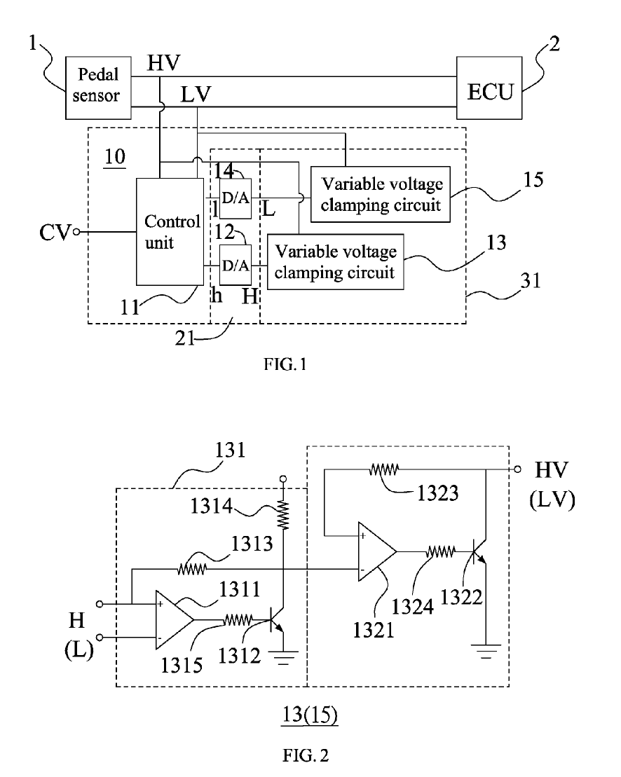

FIG. 1 is a functional block diagram showing a vehicle throttle locking circuit according to an embodiment of the present invention. As illustrated, the throttle locking circuit 10 is applied to a vehicle equipped with an accelerator pedal sensor 1 and an Electronic Control Unit (ECU) 2. The pedal sensor 1 outputs detection voltages including a high voltage HV and a low voltage LV corresponding to a depth of the pedal being stepped on to the ECU 2 so that the ECU 2 is able to control the acceleration and speed of the vehicle.

In FIG. 1, the throttle locking circuit 10 includes a control unit 11, a digital-analog (D/A) conversion unit 21 including D/A converters 12 and 14, and a variable voltage clamping unit 31 including variable voltage clamping circuits 13 and 15.

The control unit n is coupled to the pedal sensor 1 and receives a clamping actuation signal CV initiated by a user or by an anti-theft device. When triggered by the clamping actuation signal CV, the control unit n outputs digital clamping voltages including a high digital value (h) and a low digital value (l) in accordance with the detection voltages HV and LV.

The digital clamping voltages of high digital value (h) and low digital value (l) output from the control unit n are converted by the D/A converters 12 and 14 of the D/A conversion unit 21 into analog clamping voltages including a high analog clamping voltage H and a low analog lamping voltage L, respectively. The variable voltage clamping circuits 13 and 15 of the variable voltage clamping unit 31 then clamp the high and low detection voltages HV and LV according to high and low analog clamping voltages H and L, respectively.

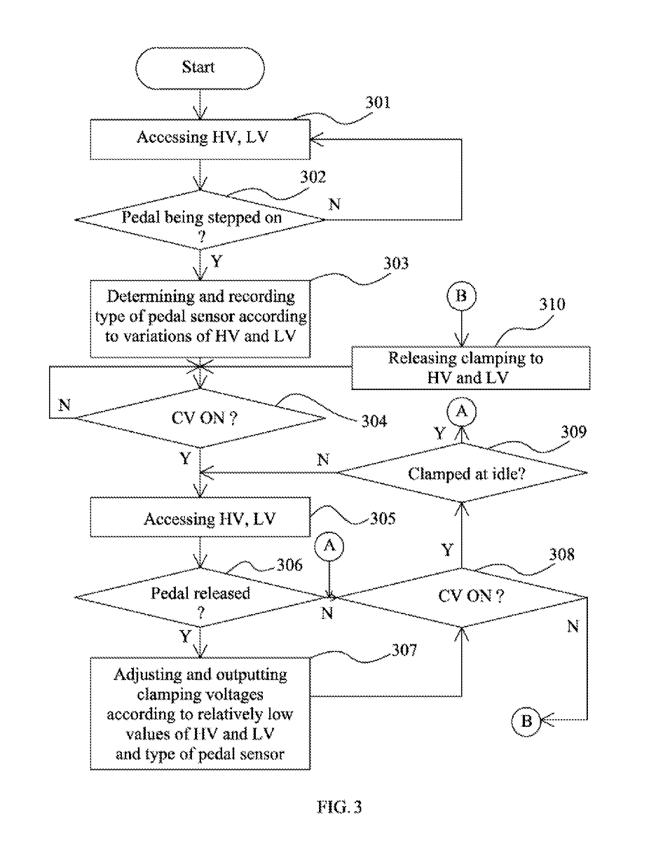

FIG. 2 is a schematic diagram showing the variable voltage clamping circuit 13 or 15 of FIG. 1. As illustrated, the high and low analog clamping voltages H and L output from the D/A converters 12 and 14 are differential voltages. They are first amplified by a differential amplifier 131 of the variable voltage clamp circuit 13 or 15 positioned between the D/A converters 12 or 14 and an operational amplifier 1321. The amplified result is then fed into a negative input terminal of the operational amplifier 1321 so as to conduct clamping to the detection voltages including the high and low voltages HV and LV.

In FIG. 2, the differential amplifier 131 includes an operational amplifier 1311, resistors 1313, 1314, and 1315, and a transistor 1312. The operational amplifier 1311 has a positive input terminal, a negative input terminal, and an output terminal. The positive and negative input terminals receive differential voltages of the high and low analog clamping voltages H and L, respectively. The resistor 1315 has an end coupled to the output terminal of the operational amplifier 1311. The transistor 1312 has its base coupled to another end of the resistor 1315, its emitter connected to ground, and its collector coupled to an end of the resistor 1313. Another end of the resistor 1313 is coupled to the positive input terminal of the operational amplifier 1311. The resistor 1314 has its two ends coupled to the collector of the transistor 1312 and a power source, respectively.

The high and low analog clamping voltages H and L amplified by the differential amplifier 131 are fed into the negative input terminals of the operational amplifiers 1321 of the variable voltage clamping circuits 13 and 15. Or, if the high and low analog clamping voltages H and L output from the D/A converters 12 and 14 are not differential voltages, they may be fed directly into the negative input terminals of the operational amplifiers 1321 of the variable voltage clamping circuits 13 and 15. The clamping to the detection voltages including the high and low voltages HV and LV are then conducted.

As shown in FIG. 2, in addition to the optional differential amplifier 131, the variable voltage clamping circuit 13 or 15 further includes an operational amplifier 1321, resistors 1323 and 1324, and a transistor 1322. The operational amplifier 1321 has a positive input terminal, a negative input terminal, and an output terminal. The negative input terminal receives the high or low analog clamping voltages H or L, respectively. The resistor 1324 has an end coupled to the output terminal of the operational amplifier 1321. The transistor 1322 has its base coupled to another end of the resistor 1324, its emitter connected to ground, and its collector coupled to an end of the resistor 1323. Another end of the resistor 1323 is coupled to the positive input terminal of the operational amplifier 1321.

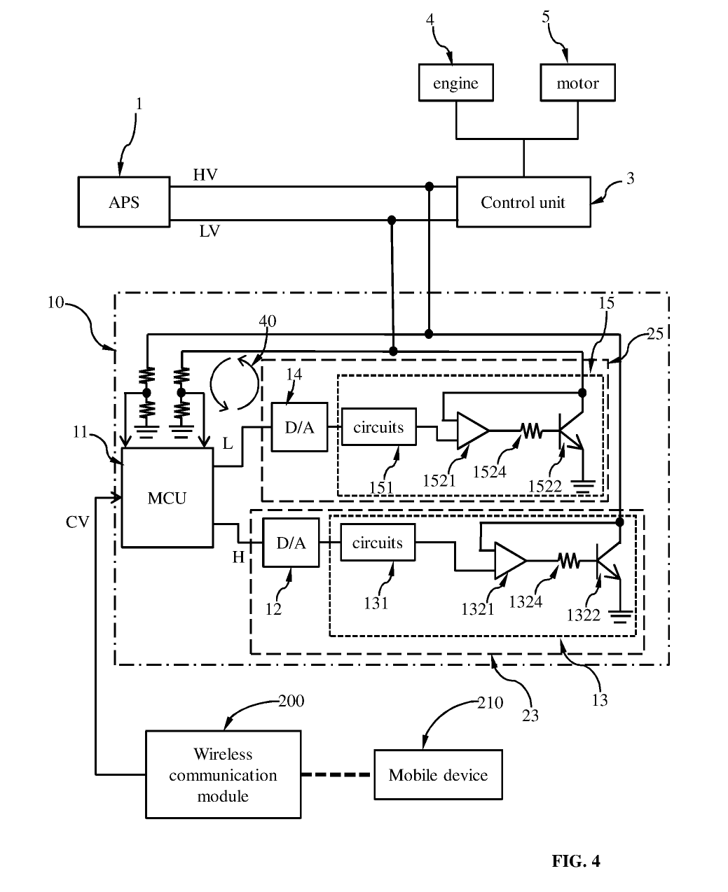

FIG. 3 is a flow diagram showing a vehicle throttle locking method according to an embodiment of the present invention. Firstly, in step 301, a control unit 11 accesses detection voltages including a high voltage HV and a low voltage LV from an accelerator pedal sensor 1. The process then enters step 302, and a status of the pedal is determined. If the vehicle is idle and the pedal is not stepped on, the process returns to step 301. Otherwise, the process enters step 303 and a type of the pedal sensor 1 is determined and recorded according to variations of the high and low voltage HV and LV. The initialization of the process is completed at this stage.

In general, the pedal sensor 1 may be of one of the following types. Firstly, the pedal sensor 1 may be of a parallel type where the high and low voltages HV and LV of the detection voltages have an identical initial value for idle and identical increments. For example, the high and low voltages HV and LV both vary within the same range between 0.3V and 4V. Secondly, the pedal sensor may be of a fixed parallel type where the high and low voltages HV and LV of the detection voltages have different initial values for idle but identical increments. For example, the high voltage HV varies within a range between 1.6V and 4V whereas the low voltage LV varies within a range between 0.8V and 3.2V. Thirdly, the pedal sensor may be of a multiple type where the high and low voltages HV and LV of the detection voltages have different initial values and different increments but one is a multiple of the other. For example, the high voltage HV varies within a range between 0.7V and 4V whereas the low voltage LV varies within a range between 0.35V and 2V.

Therefore, step 303 is able to determine and record the type of the pedal sensor 1 according to variations of the high and low voltage HV and LV for subsequent steps.

In step 304, whether a clamping actuation signal CV is initiated is determined. If the clamping actuation signal CV is not initiated, the process returns to step 304. Otherwise, the process enters step 305 where the high and low voltages HV and LV of the detection voltages output from the pedal sensor 1 is accessed. Then, in step 306, whether the pedal is released to reduce speed is determined. If the pedal is not released to reduce speed, the process enters step 308. Otherwise, if the pedal is released to reduce speed, the process enters step 307 where digital clamping voltages are adjusted according to relatively low (or high) values of the high and low voltages HV and LV and the type of the pedal sensor 1 recorded in step 303, and output the digital clamping voltages.

For example, if the pedal sensor 1 is of the parallel type, and the high and low voltages HV and LV are both 3.6V before the pedal is released, and the high voltage HV becomes 3.0V and the low voltage LV becomes 2.9V after the pedal is released, step 307 adjusts and output digital clamping voltages so that the high and low voltages HV and LV are both clamped at the relatively low value 2.9V.

If the pedal sensor 1 is of the fixed parallel type, and the high and low voltages HV and LV are 3.6V and 2.8V, respectively, before the pedal is released, and the high voltage HV becomes 3.0V and the low voltage LV becomes 2.1V after the pedal is released, step 307 adjusts and output digital clamping voltages so that the high and low voltages HV and LV are clamped at the relatively low values 2.9V and 2.1V, respectively.

If the pedal sensor 1 is of the multiple type, and the high and low voltages HV and LV are 3.6V and 1.8V, respectively, before the pedal is released, and the high voltage HV becomes 3.0V and the low voltage LV becomes 1.4V after the pedal is released, step 307 adjusts and output digital clamping voltages so that the high and low voltages HV and LV are clamped at the relatively low values 2.8V and 1.4V, respectively.

In step 308, whether the clamping actuation signal CV is still ON is determined. If it is not ON, the process enters step 310 and clamping to the high and low voltages HV and LV are released so that the vehicle is restored a normal driving condition. Otherwise, the process enters step 309 and whether the detection voltages are already clamped at an idle condition is determined. If yes, the process returns to the step 308 so as to wait for the clamping actuation signal CV to be OFF and to release the clamping to the high and low voltages HV and LV. Otherwise, the process enters step 305 and repeats a next cycle of operation.

FIG. 4 illustrates an embodiment of the present invention which limits speed of a vehicle. In this drawing, similar reference numerals with FIG. 1 and FIG. 2 will refer to the same parts or devices. An APS(accelerator pedal sensor) or pedal sensor 1 is provided for sensing degree of a user preferred the vehicle's speed or movement and outputs detection voltages. In one embodiment, the detection voltages include a first detection voltage which is a high voltage and a second detection voltage which is a low voltage. For example, when the pedal of the vehicle is released, the first detection voltage may be 0.4V while the second detection voltage may be 0.2V. When the pedal of the vehicle is pressed to the ultimate position, the first detection voltage may be 4V while the second detection voltage may be 2V. Thus, the first detection voltage between 0.4V and 4V while the second detection voltage between 0.2V to 2V may represent how fast of the vehicle. The design of the first and second detection voltages may vary with vehicle manufacturers.

The control unit 3 in this embodiment may be ECU(Electronic Control Unit) or EMCU(Electric Motor Control Unit), or combination of both. When the APS 1 provides the detection voltages, the control unit 3 will control the amount of gasoline or diesel to engine 4 of the vehicle, or electric power to the motor 5 of the vehicle. If the vehicle is powered by engine 3 only, the control unit 3 will include ECU only. If the vehicle is powered by pure electricity, the control unit 3 will include EMCU only. If the vehicle is hybrid power, the control unit 3 will include ECU and EMCU both.

A controller 11, which is a MCU(Micro Controller Unit), receives a clamping actuation signal CV from a wireless communication module 200, to provide clamping voltage signals which includes a first clamping voltage signal and a second clamping voltage signal, in according to the detection voltages.

A variable voltage clamping device includes a first variable voltage clamping unit 23 for clamping the first detection voltage and a second variable voltage clamping unit 25 for clamping the second detection voltage respectively. The first variable voltage clamping unit 23 includes a first D/A converter 12 and a first variable voltage clamping circuit 13, while the second variable voltage clamping unit 25 includes a second D/A converter 14 and a second variable voltage clamping circuit 15. The clamping voltage signals from the MCU n are digital signals and should be transferred to analog signals.

In the present invention, the first operating amplifier 1321 in the first variable voltage clamping circuit 13 is crucial. The first clamping voltage signal transferred to analog signal will be sent to the operating amplifier 1321 to turn on the transistor 1322 such that a specific amount of the first detection voltage will be grounded and thus the first detection voltage is clamped. A signal from the operating amplifier 1321 will be sent to the MCU 11 to confirm the clamped detection voltage. The same operation is performed in the second variable voltage clamping circuit 15. Thus, a closed loop 40 is operated in the system 10.

In the present invention, the clamping voltage is programmable. When detection signals are sent from the APS 1, the clamping voltages can be determined at first values, for example 2.2V when the detection voltage is 2V, and the vehicle's speed is limited to a first speed, when the MCU 11 receives a clamping actuation signal. Then, the detection signals are lowered from the APS 1, for example 1.5V, the clamping voltages can be determined at second values, for example 1.7V, and the vehicle's speed is lowered. The steps are repeated till the vehicle to stop, for example the idle engine.

The clamping actuation signal CV is provided from a wireless communication module 200 which, in a preferred embodiment, may include a sim card to communicate with a mobile device 210 via 2G/3G/4G/5G or maybe the next communication protocols. In the present invention, the wireless communication comprises at least one RF(Radio Frequency) module to remote communicate with other device. The mobile device 210 may be a cellular phone or tablet phone, and hence users can instruct the vehicle's status by using the mobile device 210 through the software or applications.

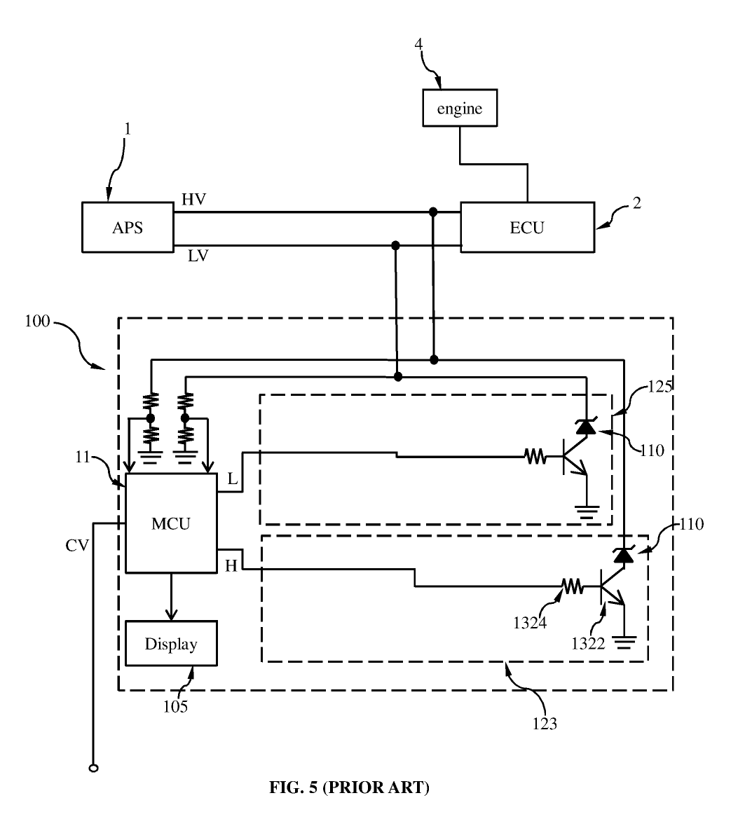

Please refer to FIG. 5, which illustrate a conventional system for limiting vehicle's speed. Please also notice that this art is equivalent to US 2011/0295477, filed by Wang et al. The clamping voltage is determined by the Zenor diodes no in the first voltage clamping unit 123 and second voltage clamping unit 125 both. It can be shown that each Zenor diode in FIG. 6C of the US 2011/0295477 can be referred to Zeno diodes no in the FIG. 5. In this configuration, clamping voltage is determined by the Zenor diodes only and should be configured in advance for a specific vehicle. For example, if the first detection voltage is ranged from 0.4V to 4V, one Zenor diode should be determined to clamping voltage at 3.6V. Another way is to configure several Zenor diodes in series to the clamping voltage at 3.6V. In FIG. 6C of the US 2011/0295477, one side of the clamping circuit is ranged from 0.7V to 3.2V and the other side is ranged from 1.4V to 3.9V. If the clamping voltage should be at 2.0V at left hand side and 3.2V at right hand side, at least four Zenor diodes are necessary with the fourth transistor on at left hand side and at least 5 Zenor diodes are necessary with the fifth transistor on at right hand side. In this configuration, for some other brand vehicle, another transistor should be turned on and may be designed again; that means this art is not programmable.

Moreover, in this art, the system 100 in FIG. 5 is open circuit; that means the voltage clamping circuits 123 and 125 can't feedback any signals to the MCU 11 and a display 105 is necessary to illustrate if the detection voltage is lowered to the clamped voltage.

Furthermore, the detection voltages can't be lowered to the clamping voltages gradually. When the lock signal CV is sent to the MCU 11, the variable voltage clamping circuits 13 and 15 will lower the detection voltages to the clamping voltages at once! That's dangerous in some particular environment and situations.

In summary, the present invention provides a system for limiting vehicle's speed. A variable voltage clamping device is provided that values of the clamping voltages can be determined by software directly without hardware correction. It should be much better for all vehicles' designs in engine control. In addition, close loop is formed between the MCU and the variable voltage clamping device, the clamping voltage can be detected and determined according to the pedal's movement. Thus, vehicle's speed can be lowered to stop gradually. Not only this invention can be applied to the gasoline or diesel engine car model, but also to the hybrid car or pure EV(Electric Vehicle) model.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A system for limiting speed of a vehicle, comprising:
a controller, coupled to a pedal sensor and a control unit of the vehicle, for receiving a clamping actuation signal, wherein the pedal sensor outputs detection voltages and the control unit determines status of the vehicle; and
a variable voltage clamping device, coupling to the pedal sensor, the control unit, and said controller, for clamping the detection voltages from the pedal sensor to the control unit,
wherein said controller, according to the detection voltages, outputs clamping voltage signals to said variable voltage clamping device to gradually lower the detection voltages to clamping voltages, when said controller receives the clamping actuation signal, if the vehicle is moving initially.

2. The system according to claim 1, wherein the detection voltages comprise a first detection voltage and a second detection voltage lower than the first detection voltage.

3. The system according to claim 2, wherein said variable voltage clamping device comprises a first variable voltage clamping unit for clamping the first detection voltage and a second variable voltage clamping unit for clamping the second detection voltage.

4. The system according to claim 3, wherein said first variable voltage clamping unit comprises a first digital-analog converter and a first variable voltage clamping circuit, and said second variable voltage clamping unit comprises a second digital-analog converter and a second variable voltage clamping circuit.

5. The system according to claim 4, wherein said first variable voltage clamping circuit comprises a first operational amplifier and said second variable voltage clamping circuit comprises a second operational amplifier.

6. The system according to claim 5, wherein the clamping voltages comprises a first clamping voltage and a second clamping voltage.

7. The system according to claim 6, wherein the clamping voltage signals comprise a first clamping voltage signal being transferred to the first clamping voltage by said first variable voltage clamping unit and a second voltage signal being transferred to the second clamping voltage by said second variable voltage clamping unit.

8. The system according to claim 7, wherein an operating loop is formed among the pedal sensor, the control unit, said controller, and said variable voltage clamping device.

9. The system according to claim 8, wherein the control unit comprises an electronic control unit for controlling an engine of the vehicle.

10. The system according to claim 9, wherein the clamping actuation signal is provided from a wireless communication module, such that an instruction for limiting speed of the vehicle can be sent from a mobile device.

11. The system according to claim 9, wherein the control unit comprises an electric motor control unit for controlling a motor of the vehicle.

12. The system according to claim n, wherein the clamping actuation signal is provided from a wireless communication module, such that an instruction for limiting speed of the vehicle can be sent from a mobile device.

13. The system according to claim 8, wherein the control unit comprises an electric motor control unit for controlling a motor of the vehicle.

14. The system according to claim 13, wherein the clamping actuation signal is provided from a wireless communication module, such that an instruction for limiting speed of the vehicle can be sent from a mobile device.

15. A system for limiting speed of a vehicle, comprising:
a controller, coupled to a pedal sensor and a control unit of the vehicle, for receiving a clamping actuation signal, wherein the pedal sensor outputs a first detection voltage and a second detection voltage, and the control unit determines status of the vehicle;
means for clamping the detection voltage, coupling to the pedal sensor, the control unit, and said controller, including a first variable voltage clamping unit for clamping the first detection voltage from the pedal sensor to the control unit and a second variable voltage clamping unit for clamping the second detection voltage from the pedal sensor to the control unit respectively,
wherein said controller, according to the first detection voltage and the second detection voltage, outputs a first clamping voltage signal and a second clamping voltage signal to said clamping means to gradually lower the first detection voltage and the second detection voltage to the first clamping voltage and the second clamping voltage respectively.

16. The system according to claim 15, wherein an operating loop is formed among the pedal sensor, the control unit, said controller, and said variable voltage clamping device.

17. The system according to claim 16, wherein the control unit comprises an electronic control unit for controlling an engine of the vehicle.

18. The system according to claim 17, wherein the control unit comprises an electric motor control unit for controlling a motor of the vehicle.

19. The system according to claim 18, wherein the clamping actuation signal is provided from a wireless communication module, such that an instruction for limiting speed of the vehicle can be sent from a mobile device.

20. The system according to claim 17, wherein the control unit comprises an electric motor control unit for controlling a motor of the vehicle.
